(19) United States
(12) Patent Application Publication
(10) Pub. No.: US 2015/0025951 A1
(43) Pub. Date: Jan. 22, 2015

(54) Incentive Providing Task Management System

(71) Applicant: Jie TAN, Tarrytown, NY (US)

(72) Inventor: Jie TAN, Tarrytown, NY (US)

(21) Appl. No.: 13/947,089

(22) Filed: Jul. 21, 2013

(51) Int. Cl. G06Q 30/02

(52) U.S. Cl. CPC G06Q 30/0208
USPC 705/14.11; 705/14.17

(57) ABSTRACT

An incentive providing task management system is disclosed. A plurality of providers are enabled to directly provide financial incentives to a user in exchange for a specific user performance. A user is enabled to set up a trust account on the system to accumulate the financial incentives. A user task performance may include a school study, a feedback to teachers or a feedback about a medicine or a political survey, or a contracted task performance between two contracting parties.

### CROSS-REFERENCE

This is Application is a continuation-in-part to the U.S. Non-provisional application Ser. No. 13/784,943, filed on Mar. 5, 2013, from which priority is claimed, and the entirety of which is hereby incorporated by reference. This Application is also a continuation-in-part to the U.S. Non-Provisional application Ser. No. 13/927,070, filed on Jun. 25, 2013, from which priority is claimed and the entirety of which is hereby incorporated by reference. The application also claims the priority of the U.S. Provisional Application No. 61/745,747, filed on Dec. 24, 2012, the entirety of which is hereby incorporated by reference.

### DESCRIPTION OF RELATED ART

The present application relates to web-based online task management system, more particularly, an electronic computer and mobile network based task management system in which a conditioned financial award is provided when a specified task is performed and approved.

Note that the points discussed below may reflect the hindsight gained from the disclosed inventions, and are not necessarily admitted to be prior art.

Current task management systems only focus on the content of the tasks, and are generally for self-reminding or office management, for example, setting up a to-do list, a calendar, an alarm, scheduling system, etc.

In the education field, there are course management and grading systems for teachers that monitor students' attendances, homework and school performances.

However, none of the systems satisfy the needs involved with inter-personal task management where a contract or a conditioned financial incentive will be provided upon the performance of a task.

### SUMMARY

The present application discloses an Incentive Providing Task Management System that allows a task provider to set up a task and a financial incentive and allows a different person, a user, to accept and perform the task and to receive the financial award upon satisfactory performance of the task.

A computer enabled network task management system that sets transferrable financial incentives and goal for a user to perform a task would initiate a student to learn under a financial incentive and would provide an alternative for teachers and parents to motivate their students or children to learn or perform tasks that they otherwise lack of initial interests.

A computer enabled network task management system that executes a conditioned financial agreement will allow an inter-personal contractual work be enforced immediately to reduce the overhead of enforcing the inter-personal contracts. A user or contractor no longer needs to worry about collecting money once a task is performed and accepted.

In one embodiment, a task provider is enabled to set up an escrow or trust account on the system.

In one aspect of an embodiment, a task provider is enabled to set up a task, and associate such task with a conditioned financial incentive and an escrow or trust account on the system.

In another aspect of an embodiment, a user, or a task performer, is enabled to set up a trust account on the system.

In another aspect of an embodiment, a user or a task performer is enabled to perform a task, and associate such performance with his or her trust account on the system.

In another aspect of an embodiment, a user or a task performer is enabled to receive a conditioned financial incentive associated with a task from the task provider into his trust account on the system.

In one embodiment, a user or a task performer is enabled to associate a long term goal to a trust account on the system; and in another aspect of an embodiment, a user or a task performer, is enabled to accumulate any financial incentives in a trust account on the system.

In one embodiment, a registered user is enabled to search incentive providing programs offered on the system, by key words, by personal information, and by incentive amount or by the most recent offers; is enabled to enter such programs with a single click.

In one embodiment, a task provider is enabled to change and update the tasks according to feedback and needs, or according the progress of a user.

In one embodiment, a task is related with educational activities or a part of parenting activities, provided by schoolteachers or parents.

In one embodiment, the source of financial incentives may be provided by government grants, charity donations, individual or corporate sponsors, or by parents or a caretaker of the user, or from school tuitions of a student user.

In one embodiment, a search engine application for this system is automatically installed to a user's smart phone, and a user can enter into a provider's program through clicking on the application installed on the cell phone.

In one embodiment, a financial incentive is automatically transferred to a user's trust account on the system upon a satisfactory performance or manual approval of the task provider.

In one embodiment, a task provider is enabled to post or create incentive programs directly to a particular user on the system.

In one embodiment, a task provider is a temporary work hirer and a user is a temporary worker or a contractor, and a task is a performance of contract.

The disclosed innovation, in various embodiments, provides one or more of at least the listed advantages. However, not all of these advantages result from every one of the innovations disclosed, and this list of advantages does not limit the various claimed inventions.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows an example set of functional components for an Incentive Providing Task Management System in accordance with this application.

FIG. 2 schematically shows an example set of transactions in an Incentive Providing Task Management System in accordance with this application.

FIG. 3 schematically shows an example Registration for a task provider in an Incentive Providing Task Management System in accordance with this application.

FIG. 4 schematically shows an example transactional process on a task provider side in an Incentive Providing Task Management System in accordance with this application.

FIG. 5 schematically shows an example transactional process at a user side in an Incentive Providing Task Management System in accordance with this application.

FIG. 6 schematically shows an example user interface at a user side in an Incentive Providing Task Management System in accordance with this application.

FIG. 7 schematically shows an example architecture of an transaction engine in an Incentive Providing Task Management System in accordance with this application.

FIG. 8A and 8B schematically show an example mobile user interface in an Incentive Providing Task Management System in accordance with this application.

FIG. 9 schematically shows an example Conditional Award Program in an Incentive Providing Task Management System in accordance with this application.

FIG. 10 schematically shows an example process of setting a User Trust Account associated with a long term goal in accordance with this application.

FIG. 11 schematically shows an example interaction between a user, a task provider and the Incentive Providing Task Management system in accordance with this application.

FIG. 12A shows an example web interface for performing a survey in an Incentive Providing Task Management in accordance with this application.

FIG. 12B shows an example web interface for an incentive providing Literature Study program in accordance with this application.

FIG. 12C shows an example web interface for a Trust Account Statement in accordance with this application.

FIG. 12D shows an example Provider's Account Page in accordance with this application.

FIG. 13 shows an example set of functions on the task Provider's interface in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present invention may be described herein in terms of functional block components and various processing steps in an electronic network and devices. It should be appreciated that such functional blocks may be realized by any number of hardware and/or software components configured to perform the specified functions. For example, the present invention may employ various integrated circuit components, e.g., memory elements, processing elements, logic elements, look-up tables, platforms such as IPHONE®, ANDROID®, Mac OS, UNIX/Linux, and the like, which may carry out a variety of functions under the control of one or more microprocessors or other control devices.

Similarly, the software elements of the present invention may be implemented with any programming or scripting language such as C, C++, Java, COBOL, assembler, PERL, PHP, Python, Javascript, SQL, the like, web application frames such as Django, Ruby-on-Rails, with the various algorithms being implemented with any combination of data structures, objects, processes, routines, or other programming elements. Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

Communication between participants in the system of the present invention is accomplished through any suitable communication means, such as, for example, a telephone network, public switch telephone network, intranet, Internet, extranet, WAN, LAN, point of interaction device (e.g., point of sale device, personal digital assistant, cellular phone, kiosk terminal, automated teller machine (ATM), etc.), online communications, off-line communications, wireless communications, satellite communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

It further will be appreciated that users may interact with like the system via any input device such as a keyboard, mouse, kiosk, personal digital assistant, handheld computer (e.g., Palm Pilot®), cellular phone, and/or the like. Similarly, the invention could be used in conjunction with any type of personal computer, network computer, workstation, minicomputer, mainframe, or the like, running any operating system, such as any version of Windows, Windows NT, Windows 2000, Windows 98, Windows 95, MacOS, OS/2, BeOS, Linux, UNIX, or the like. Moreover, although the invention may be described herein as being implemented with TCP/IP communications protocols, it will be readily understood that the invention could also be implemented using IPX, Appletalk, IP-6, NetBIOS, OSI, or any number of existing or future protocols. Moreover, the system contemplates the use, sale, or distribution of any goods, services, or information over any network having similar functionality described herein.

Each participant or user of the system of the present invention, including children, teachers, parents, temporary workers and hirers, contractors, providers, students, any person including children seeking to perform a task, any person including children seeking to provide a task, may be equipped with a suitable computing system to facilitate online communications and transactions with any other participant. For example, some or all participants may have access to a computing unit in the form of a personal computer, although other types of computing units may be used, including laptops, notebooks, handheld computers, set-top boxes, kiosk terminals, and the like. Additionally other participants may have computing systems which may be implemented in the form of a computer-server, a PC server, a networked set of computers, or any other suitable implementations which are known in the art or may hereafter be devised.

The computing systems may be connected with each other via a data communications network as described more fully above. For example, the network may be a public network, which is assumed to be insecure and open to eavesdroppers. In one embodiment, the network is embodied as the Internet.

In this context, the computers may or may not be connected to the Internet at all times. For instance, the consumer's computer may employ a modem to occasionally connect to the Internet. As will be appreciated by one of ordinary skill in the art, the present invention may be embodied as a method, a data processing system, a device for data processing, and/or a computer program product. Accordingly, aspects of the present invention may take the form of an entirely software embodiment an entirely hardware embodiment, or combining aspects of both software and hardware embodiment. Furthermore, the present invention may take the font of a computer program product on a computer-readable storage medium having computer-readable program-code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e. g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose, hardware-based computer systems which perform the specified functions or steps, or suitable combinations of special purpose hardware and computer instructions.

As used herein, the terms “user” and “participant” shall interchangeably refer to any person, entity, charitable organization, machine, hardware, software, or business who accesses and uses the system of the invention. Participants in the system may interact with one another either online or off-line. As used herein, the term “online” refers to interactive communications that takes place between participants who are remotely located from one another, including communication through any of the networks or communications means described above or the like.

A “Component” term represents physical replacement part of the system that conforms to and provides an actual realization through a set of interfaces. It includes automated software virtualization interfaces that comprise all the source files, binary code, executables, scripts that are packaged for performing the intended functions.

A “system” term represents a combination of a package and an executable file. The package contains all the elements, including unique id elements, models, source files, html files, etc. that has at least one executable that realizes these interfaces to the one unique package.

An “Engine” term in this application means a computer functional modular having a set of instructions programmed to complete a specific task, solve a problem, by instructing a computer processor.

A “Method(s)” term means a method for object oriented programming code whereas it performs a subroutine and is exclusively associated with a class or an object. Normally, consists of a sequence of programming statements to perform an action, a set of parameters to customize those actions, and possibly an output value (sometimes called a return value).

A “Web-Service” term means an application layer service that executes via a public internet interface and doesn't necessarily imply to be a web site. A web service is one that can be located, discovered, and published via a network channel. Additionally, a web service can also act as an intermediary business application service agent that is an encapsulated service provider, but can also be a service requestor.

For “Network Services”, there are two types. One type of “Network Services” mean file sharing services, file services, collaboration services, and messaging. They can also be located, discovered, and published. Another type of Network Service, taking the form of a Network Interface, implements a standard connection protocol, such as Ethernet, Wireless, etc. “Service” may mean either a Network Service and/or Web Service.

A “task provider” term means a task provider other than the invention system and its administering entity. The task providers include individuals, corporations, government, charities, schools and any other organizations or persons that are not an entity associated with the administering the system of the invention. And the term “Provider” is inter exchangeable with “task provider”.

A “User Performance” is a task-oriented performance that is not an activity of purchasing. A user is required to perform an activity that is not a purchasing of an item.

A “Trust Account” is an account that is created by a trust agreement, with trustees and beneficiaries. In this application, it may be a real bank account set up in a bank with the necessary banking licenses or a virtual account that is linked to a real bank account. Balances of such account corresponds to real money balances.

An “Escrow Account” is an account that is created as deposit for a written agreement, with contracting parties. In this application, it may be a real bank account set up in a bank with the necessary banking licenses or a virtual account that is linked to a real bank account. Balances of such account corresponds to real money balances.

A “user” in this application is inter-exchangeable with a task performer who is the counter party to a task provider.

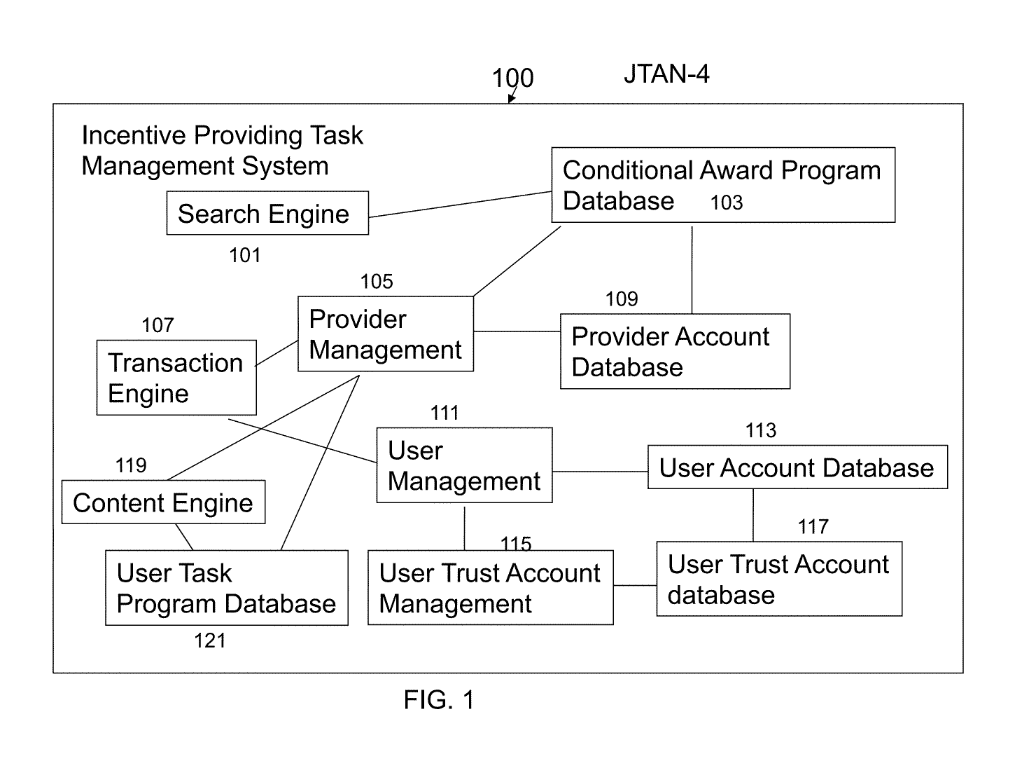

In reference to FIG. 1, an Incentive Providing Task Management System (IPTM) 100 includes a Search Engine component 101, a Database 103 for Conditional Award programs offered by various program providers, a Transaction Engine component 107 that includes a Provider Management component 105 and a User Management component 111. Provider Management component 105 provides management functions over a Provider Account Database 109 and the Conditional Award Program database 103. User Management component 111 provides management functions to User Account Database 113 and User Trust Account 115 that in turn interacts with User Trust Account database 117. User Trust Account may be a real bank account, may be setup and managed by a bank or financial entity with such license or permits under any law and regulations, or may be a virtual account set up under pool account. A Trust Account may be an ordinary trust account or a goal associated Trust Account, payable for the purpose of achieving the pre-set goals. Such goads may include paying college educations or retirement, financing a vacation, providing seed money for starting a business, and paying for patenting innovative ideas. For goal associated trust account, non-goal use of the account may encounter a penalty severe enough to discourage such use (for example, a 10% fee). The system entity of this invention can act as the trustee or co-trustee for the Trust Accounts or the escrow accounts.

Content engine 119 may be provided for a provider to provide a customized user task program, and such task program can be stored in User Task Program database 121. A third party content provider can also provide their proprietary content task programs to this IPTM system, either through the API of the system or through direct uploading.

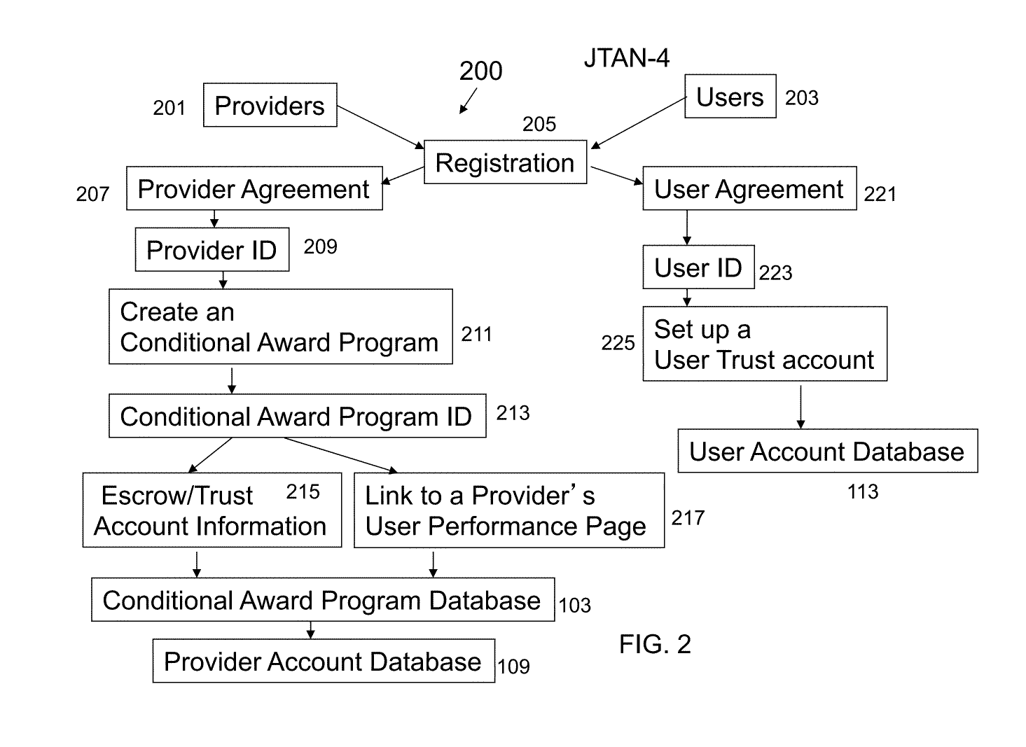

In reference to FIG. 2, an example registration process 200 is shown, by which various functioning components of the Incentive Providing Task Management (IPTM) system are created and saved into the databases. For Task Providers 201, at the system providers' web page, provider 201 goes through a Registration process 205 that inquires a number of information about the provider's identity, and creates a Provider Agreement 207 and Provider ID 209. Provider Agreement 207 may require a provider to promise or commit to set up an escrow account for financing the incentives it promises to provide through the program. The agreement allows the IPTM system to act as a trustee to the Provider's escrow account to have the right to transfer the promised awards or incentives directly from a provider's escrow account to a user's Trust Account.

After receiving a Provider ID, the provider is prompted to create a Conditional Award Program at step 211 in the system that specifies the terms for receiving an award, for example, 10 cents for submitting a survey, 2 cents a correct answer to a question, or a bonus 5 dollar for finishing a full set of exercises; 1 dollar for submitting a feedback for a product, etc. Or the task consists of performing a manual job, such as $20 dollars for mowing the lawn, $50 dollars for cleaning the house, or $65 for delivering a letter. The award can only be awarded after a user's successfully performing specific tasks specified in the Conditional Award Program. In other wards, a user must earn the conditional award by performing a required task.

With a Conditional Award ID and a Provider ID, the system then prompts the provider to set up an escrow account or account information at step 215 to authorize the direct access by the IPTM system, and link together the Award ID with the escrow account information. The system also prompts the provider to link its Provider's User Performance Page to the Conditional Award ID and system at step 217, allowing a user to enter the Provider's User Performance Page with a simple click in the system. All the information is then saved into the Provider Conditional Award Database 103, and also the Provider Account Database 109 to track and record all the incentive based programs offered by a Provider.

A Provider's User Performance Page may not be implemented directly by the IPTM system, may be implemented on the provider's own internet service site using other content creating programs. While this arrangement would provide the maximum control to the provider to manage the content and the data that it wishes to collect that it is most suited to analyze, alternatively for the providers who do not operate their own internet site, they may directly implement a User Performance Page on the IPTM system using a Content Creating Engine 119 provided by the system. Content Creating Engine 119 may contain multiple templates and set of editing and designing tools for creating forms and text and drawings and for saving to the system.

For a User 203, it also goes through the general registration process of 205 by providing the identity information. A User Agreement 221 and a User ID 223 are then generated to authorize the system to be a trustee/co-trustee to set up a Trust Account for the user with a bank or a bank account at step 225. The user is prompted to select a long term goal or aim for the Trust Account, among the example choices are: paying college educations or retirement, financing a vacation, providing seed money for starting a business, and paying for patenting innovative ideas. However, once a goal is set for a given Trust Account, the goal may not be changed without a penalty. The goal may be changed at a later time by paying a surcharge fee, such as 10-20% of the account amount. The user information and the associated Trust Account information are then saved into a User Account Database for management by the system.

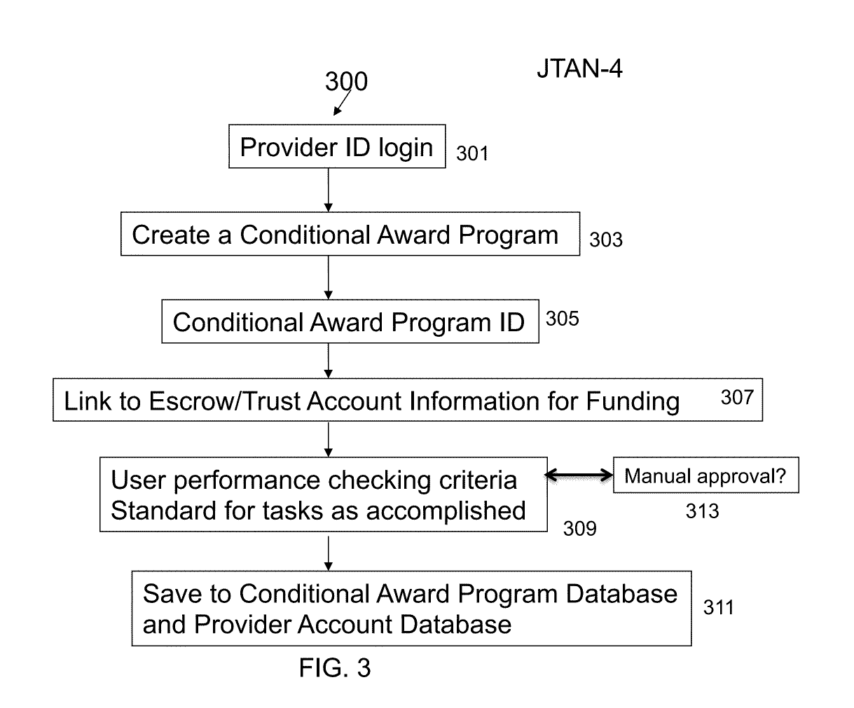

In reference to FIG. 3, for a registered Provider, process 300 is used to register a new Conditional Award Program under this provider. A provider is prompted to use its Provider ID to login to the system at step 301 to its home page in the system. At step 303, a Provider can create a new Conditional Award Program by clicking on a New Program button on its home page. The program specifies the hierarchy of awards and the conditions for such awards. A Conditional Award Program ID is then provided at step 305, and associated Escrow Account Information is provided and linked with the Program ID and accessing authorization is granted to the system at step 307. The provider can also specify a number of filtering criteria for filtering the accesses to the Escrow Account by demanding upon certain satisfactions from a user's performance at step 309. Optionally at step 313, a Provider may also specify whether such performance of the task needs to be manually approved by the provider. And the information are saved to both Conditional Award Database and Provider Account Database at step 311.

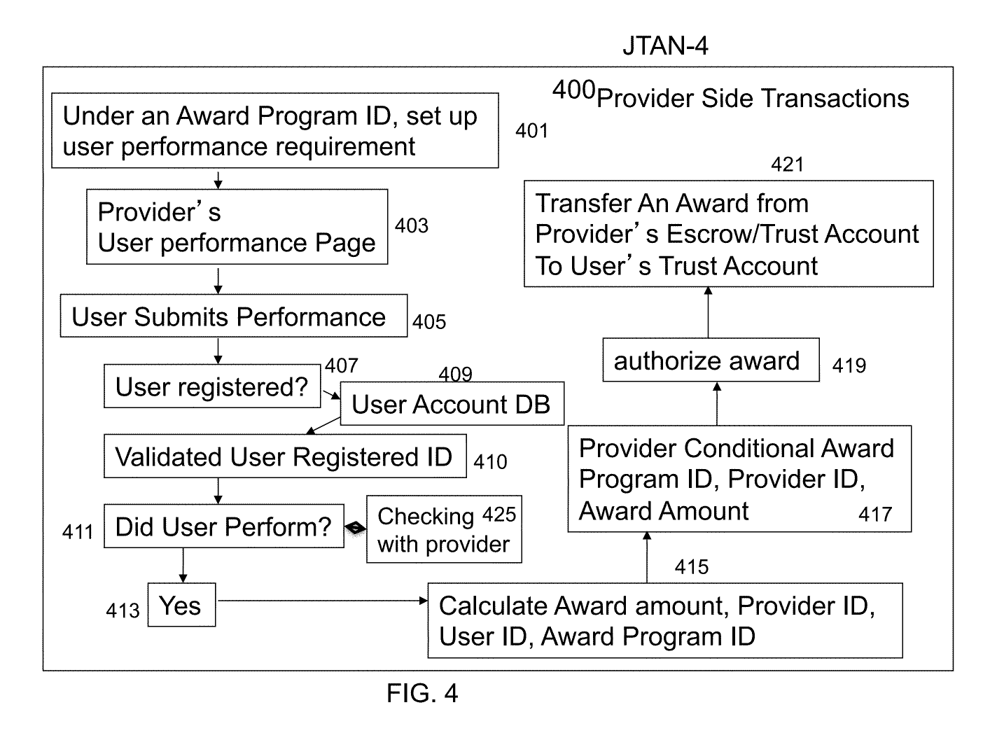

In reference to FIG. 4, a functional flow chart about the transactions 400 associated with a Provider side. At step 401, a provider that has set up a Conditional Award program with the IPTM system may either set up a user performance requirement on its own service site or on the IPTM system under the Conditional Award Program ID. At step 403, this requirement is then linked to the Provider's User Performance Page on the Provider's service site, or created on IPTM system for the Providers who do not operate an internet site themselves. The User Performance Page details about the content and data that the Provider is requiring a User to perform.

Once a User performs and submits its performance from the User Performance Page at step 405, the User Performance Page at the Provider site inquires the IPTM about the User's registration status at step 407 by prompting the User for User ID, and verifies from its User Account Database. If a User ID is not validated, the performance is temporally saved and the User is prompted to go to IPTM system to register for a User ID and to create a Trust Account. Once the User ID is validated at step 410, either the IPTM system, or alternatively, the Provider's User Performance Page checks whether the user performed as required at step 411, and if it is yes, the performance result is used to calculate the award at step 415 using the Award Program ID and the program. If the program requires the manual approval of the provider, the provider is sent a message or a text for approval at step 425. Then the Program ID, Provider ID, and User ID are used to access the User Trust Account management engine at step 419, the linked Escrow Account and the user Trust Account, and to authorize the transfer of the calculated award amount from the linked Escrow Account to the User Trust Account at step 421.

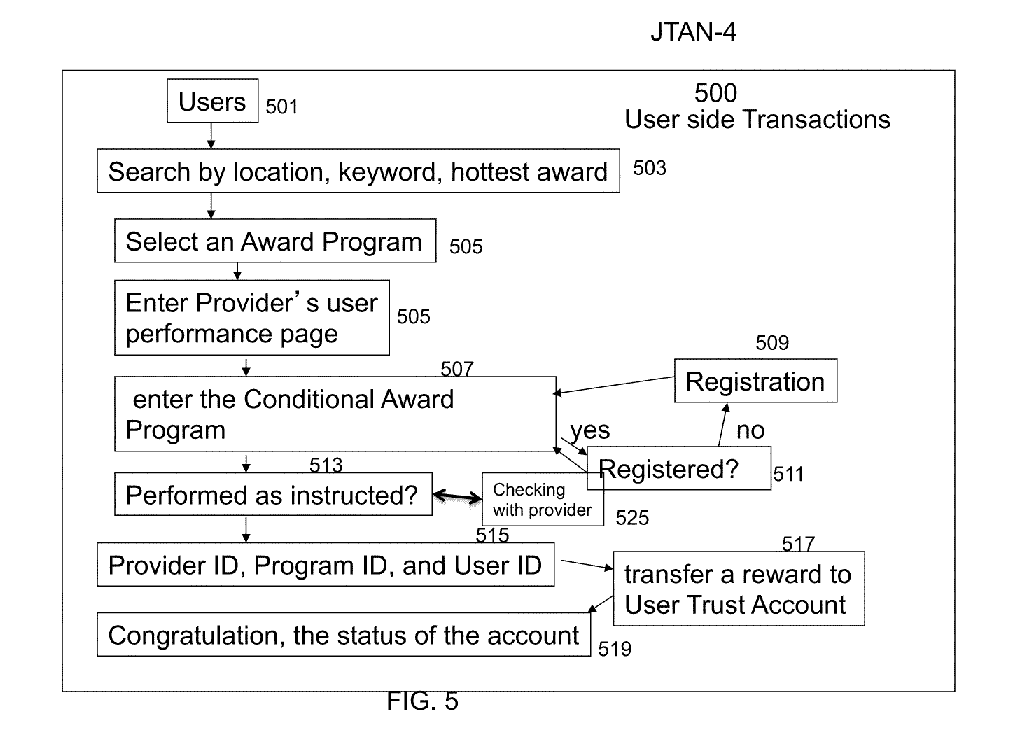

In reference to FIG. 5, an example of User side transaction chains 500 is shown. A User at step 501 can search with the Search Engine of the IPTM system, either online through the Internet, or with a cell phone application of the system, for an Incentive Program, according to its interest. The search may be conducted with key words, locations, school names, etc. At step 503, the User then selects a program of interest from the displayed Program lists with links and enters the Program Provider's User Performance Page by clicking on the link at step 505. When the User submits the performance from the Provider's User Performance Page, it automatically enters into the Conditional Award Program of the IPTM system linked with the User Performance Page at step 507, and its registration status is then checked and validated through the Registration component at steps 509 and 511. If the User is not registered, it is prompted for registration. If it is a registered user, then the User ID is retained and the system checks the performance submission to see if it is performed as instructed at step 513. If the program requires the manual approval of the provider, the provider is sent a message or a text for approval at step 525. The performance results are then converted into Award amount which, together with the Provider ID, Award Program ID and the User ID, are sent to Transaction Engine 107 to authorize a transfer and deposit of the Award amount into the User's Trust Account at step 515 and step 517. A message is then sent to the User about the completion of this transaction at step 519.

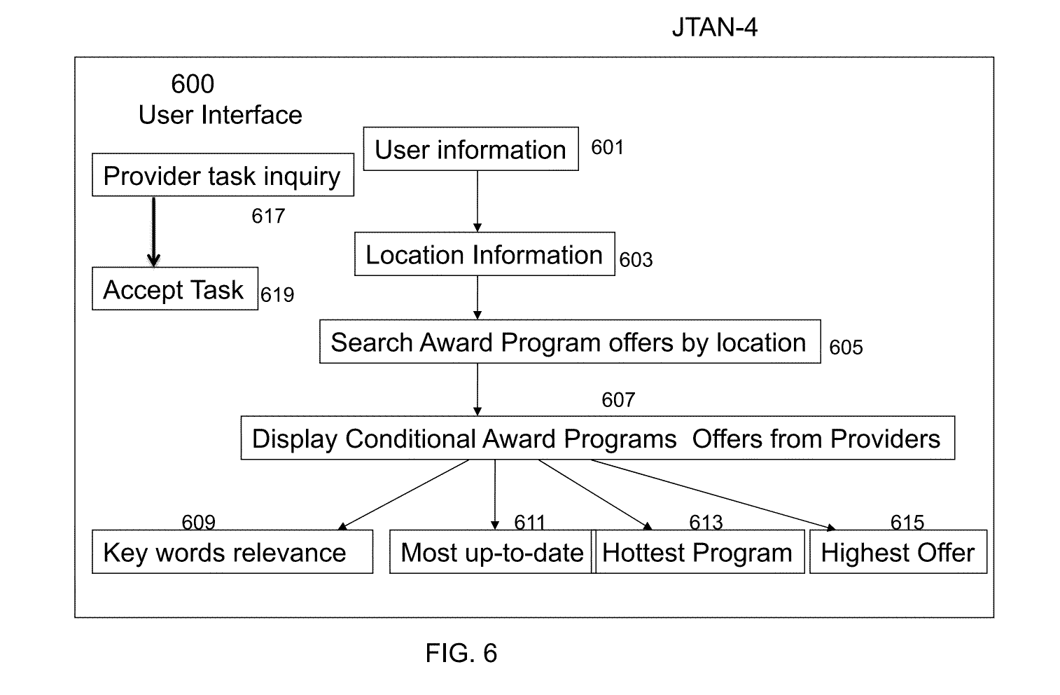

In reference to FIG. 6, an example set of inputs may be input by a user at its User Interface 600. For example, User or student information 601, location information 603 can be typed into the search box, and the system then searches the registered incentive programs at step 605. The search results of the relevant available Conditional Award Programs are then displayed at step 607. The display may also be arranged according to keywords relevance 609, most up-to-date 611, the hottest program (most popular) 613 or the highest offers 615 (highest incentives per performance, etc).

At the user interface, a list of tasks specifically sent to this user is shown through the Provider task inquiry module 617, and at which a user can accept the tasks at module 619.

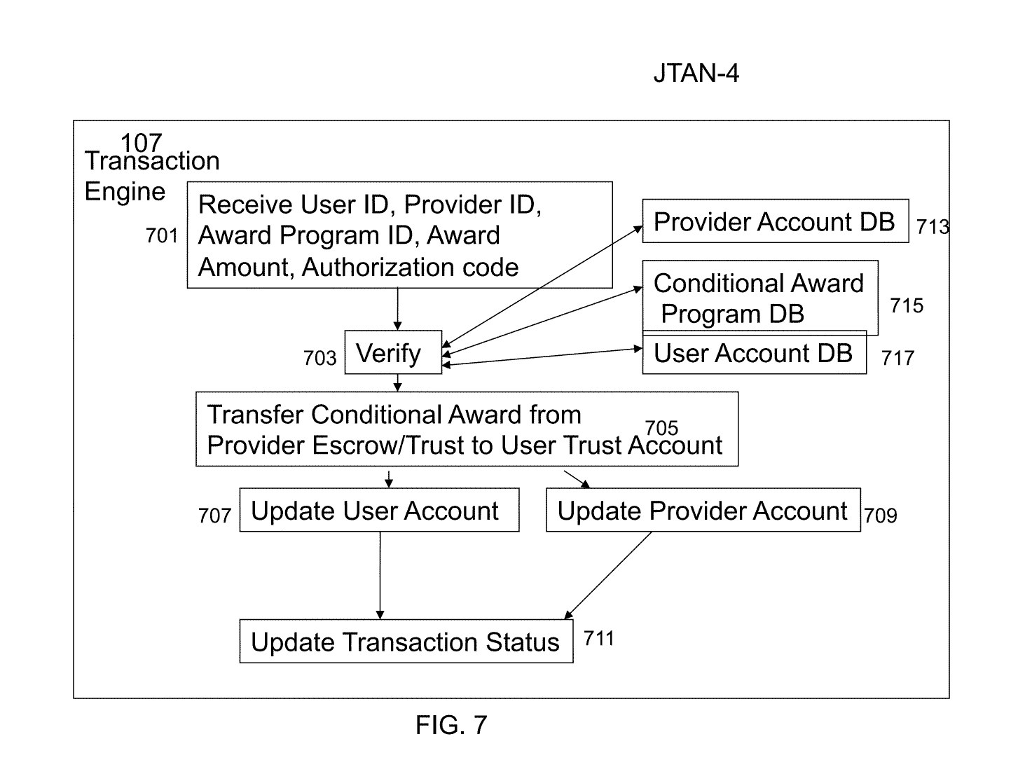

In reference to FIG. 7, an example functional flow chart of Transaction Engine 107 is shown. When the Transaction Engine 107 receives request and an authorization code from a Provider's User Performance Page, together with a User ID, Provider ID, Award Program ID and the award amount at step 701, it conducts a verification step at step 703 by accessing Provider Account Database 713, Conditional Award Database 715, and User Account Database 717. After positive validation, with the authorization code, the Transaction Engine 107 then directly access the Provider's Escrow Account to transfer the award amount to the User's Trust Account under the User ID at step 705. Then the User Account 707 and Provider Account 709 are updated and recorded with this transaction information. Transaction Status is tracked and updated accordingly at step 711.

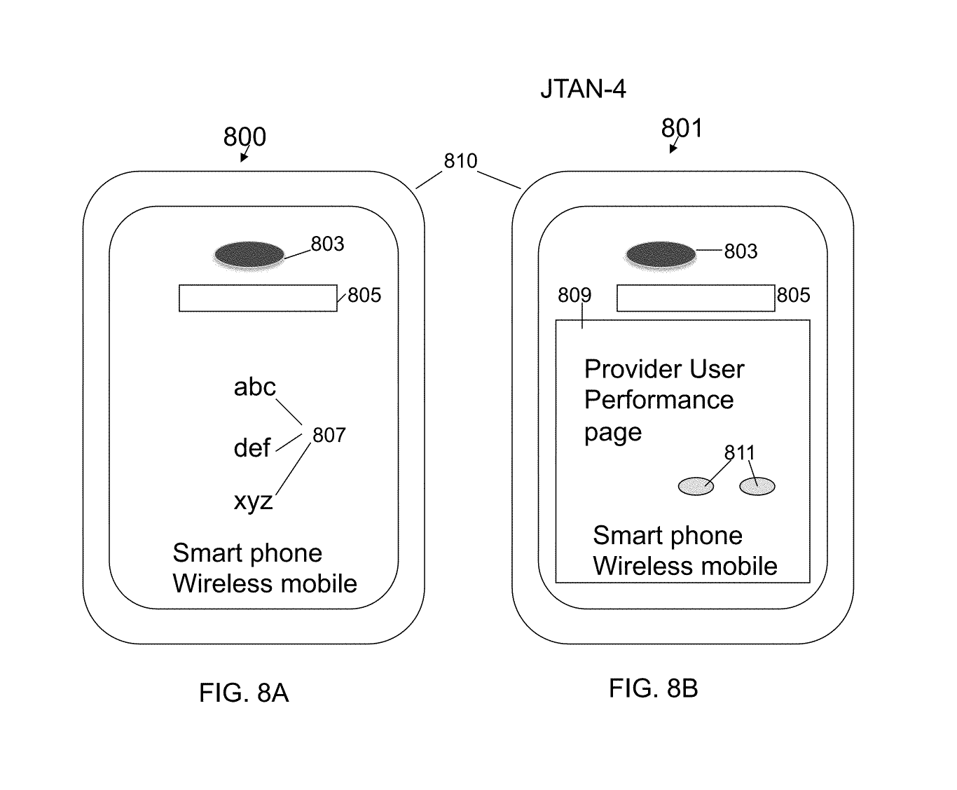

In reference to FIG. 8A, an example IPTM interface 800 for a cell phone 810. On cell phone 810, the application Icon 803 is easily located on the top of the phone. With one click on Icon 803, the application is activated and a search input box 805 is displayed. With the input of keywords, or other information, such as location information, the search results 807 are displayed as hyperlinked listings. One click on one of those hyperlinked listing items, the User is directly shown with the Provider's User Performance Page 809 with submission buttons 811 as shown in FIG. 8B.

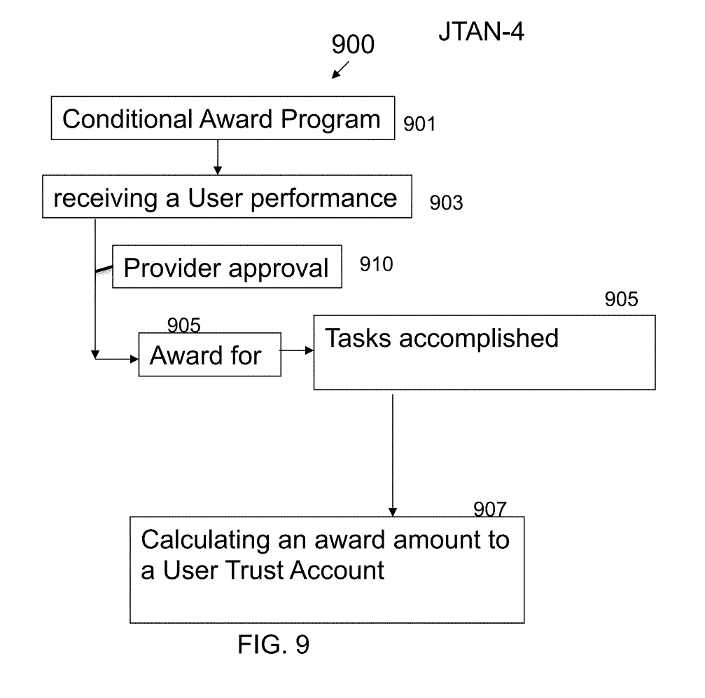

In reference to FIG. 9, an example functional flow chart 900 for a Conditional Award Program interface is shown. Once a User Performance is submitted, the Transaction Engine 107 enters the functions of the associated Conditional Award Program at step 901, and at step 903, gathers and collects the results of a user's performance from the Provider's User Performance page, and/or the provider approval 910. The tasks accomplished 905 may includes tasks that require a User, for example, to provide a feedback, answer a survey, conduct a set of literacy learning exercises, referring a friend, cleaning a house, paving a drive way, and retrieves the information from the Conditional Award Program Database about the pre-set incentives for these performances at step 905, then calculates and concludes an award for this performance at 907.

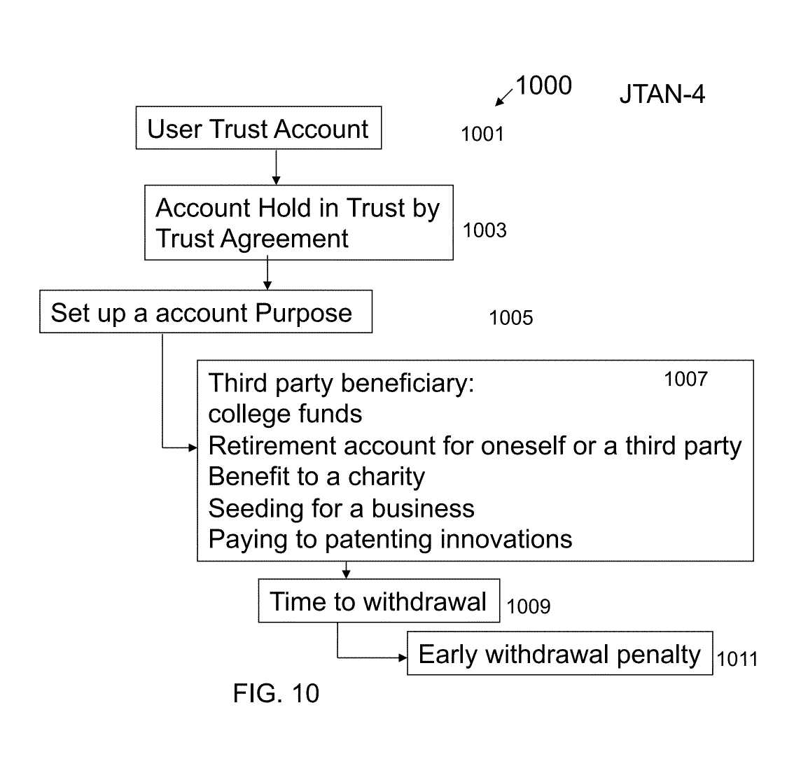

In reference to FIG. 10, an example flow chart 1000 for setting a goal associated User Trust Account is shown. At the User Trust Account set up page 1001, a User agrees to the terms on a Trust Agreement at step 1003, and then proceeds to select the long terms goals provided by the system at step 1005. The purported long term use choices may include paying for college educations, a retirement fund, a benefit fund for donating to a charity, an account for a third party beneficiary, providing seed money for starting a business, providing funds for patenting innovations. At step 1009, the length of time for the account to mature is specified, and with the selection of the length of time, a penalty for early withdrawal is also set at step 1011. The penalty may be severe, such as a 10-20% surcharge on the total amount of the account, to encourage a User to stick to its pre-set goal.

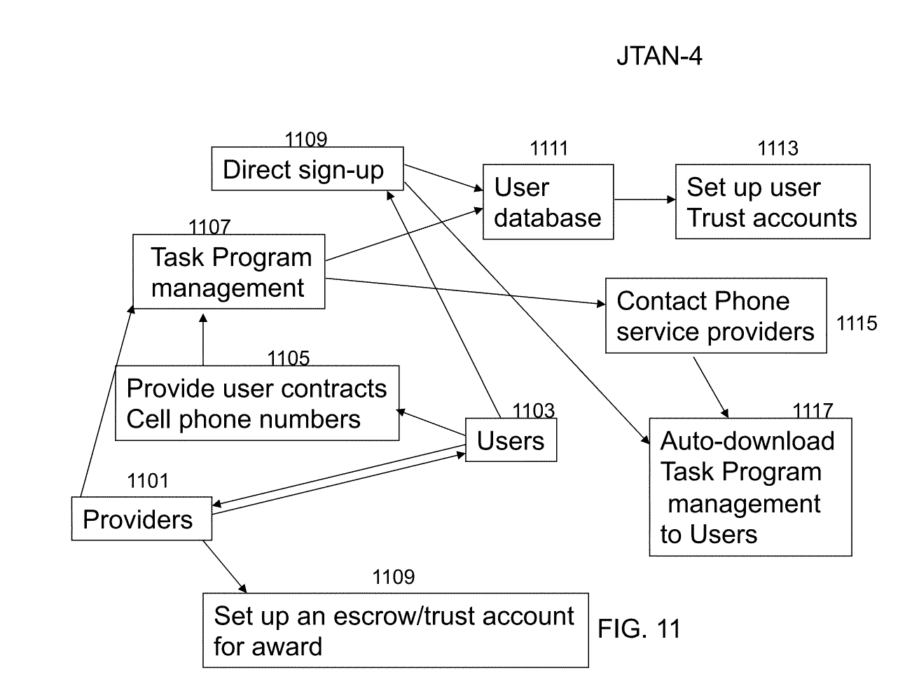

In reference to FIG. 11, an example set of interactions and automatic installation on user cell phones between the key actors and functional components are shown. A Provider 1101 can directly interact with a User 1103, and with Task Program Management 1107 of the system to set up award programs. Provider 1101 has the sole authority to set up an award escrow account 1119 and associate it with the IPTM system. A User 1103 can also direct interact with the system at 1109 for direct web-based registration or interact with a Provider by providing cell phone numbers and agreement with the Provider to sign up with a IPTM system, through step 1105. Then the system proceeds to save the Provider and User information to databases at step 1111, and set up User Trust Accounts at step 1113. With the cell numbers and User agreements, the system can direct contact the User's cell phone service provider to automatically download the system application to the user's cell phone for use at 1117.

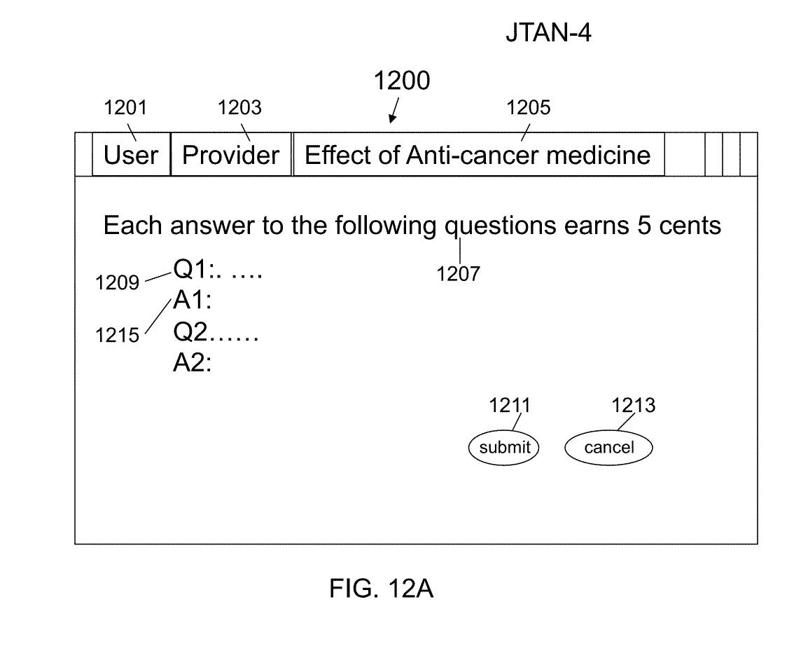

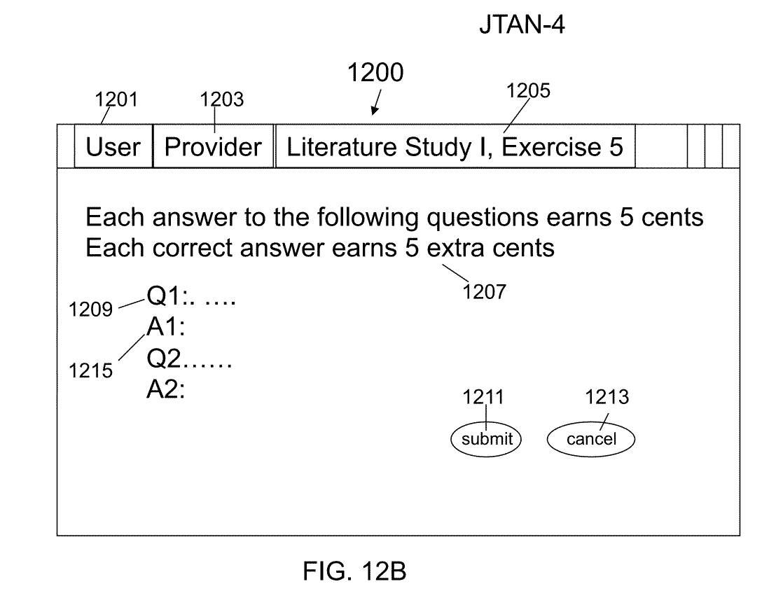

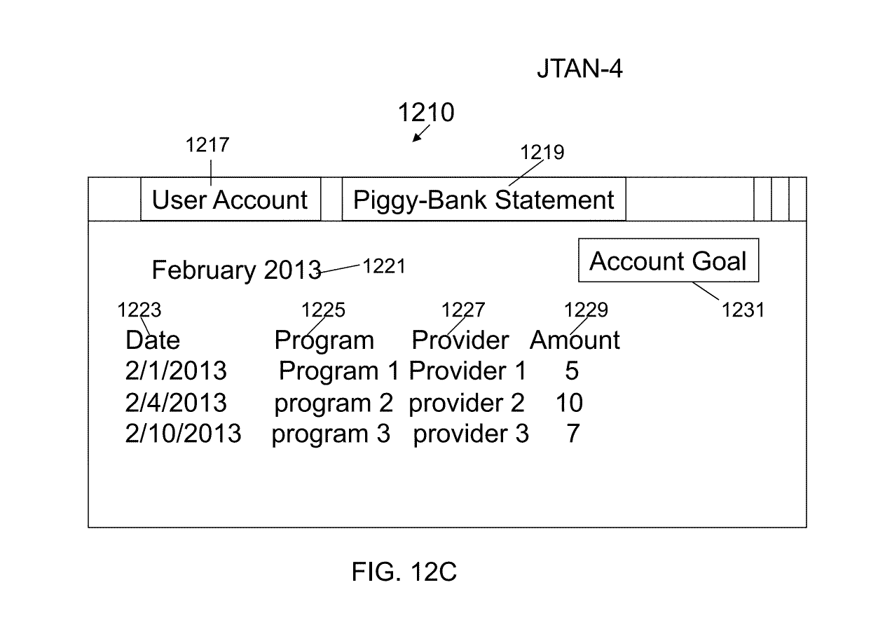

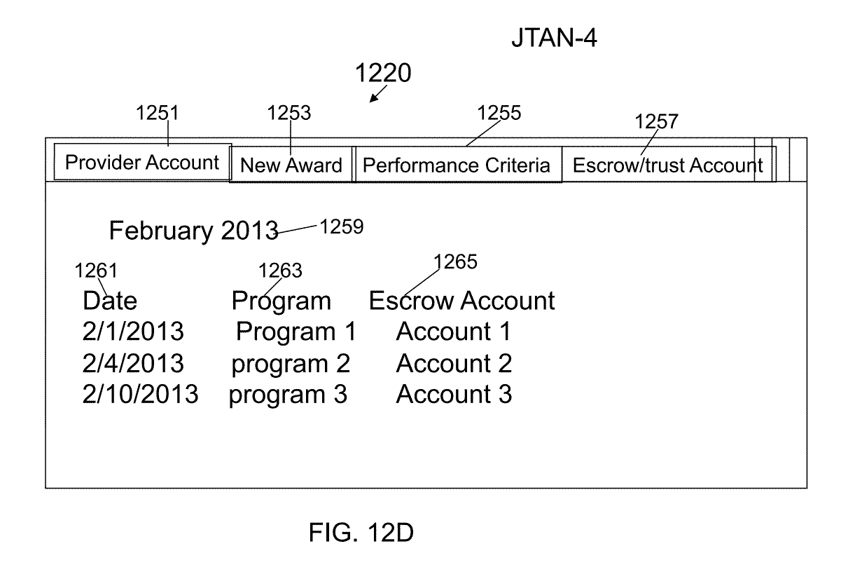

In reference to FIG. 12A, an example User Performance Page 1200 for survey of the effect of an anti-cancer medicine is shown. The Page includes information about User 1201, Provider 1203, Name of the Award Program 1205, information about the incentive offer 1207, the content of the survey questions 1209, space for input answers 1215, the submission button 1211 and a cancel button 1213. A Click on the submission button triggers the submission of the answers to the database of the provider, and the Transaction Engine of the system to calculate the awards.

Similarly, in reference to FIG. 12B, an example User Performance Page 1200 for Literature Study daily exercise is shown. And, in reference to FIG. 12C, an example User Trust Account Statement 1210 is shown. The statement may include the information of the name of user account 1217, the name of the Trust Account Statement 1219, the date period of the statement 1221, date of award transactions 1223, name of the programs 1225, provider names 1227, the amount deposited 1229, and the designated long term goal 1231.

In reference to FIG. 12D, a Provider's Account page 1220 may include a provider account name 1251, a bar button 1253 for creating new Award Programs, a bar button 1255 for specifying Performance criteria, and a bar button 1257 for providing an escrow account. The home page should include the date 1259, and a list of Programs that are already created with display of the date 1261, program name 1263, and the associated escrow account 1265.

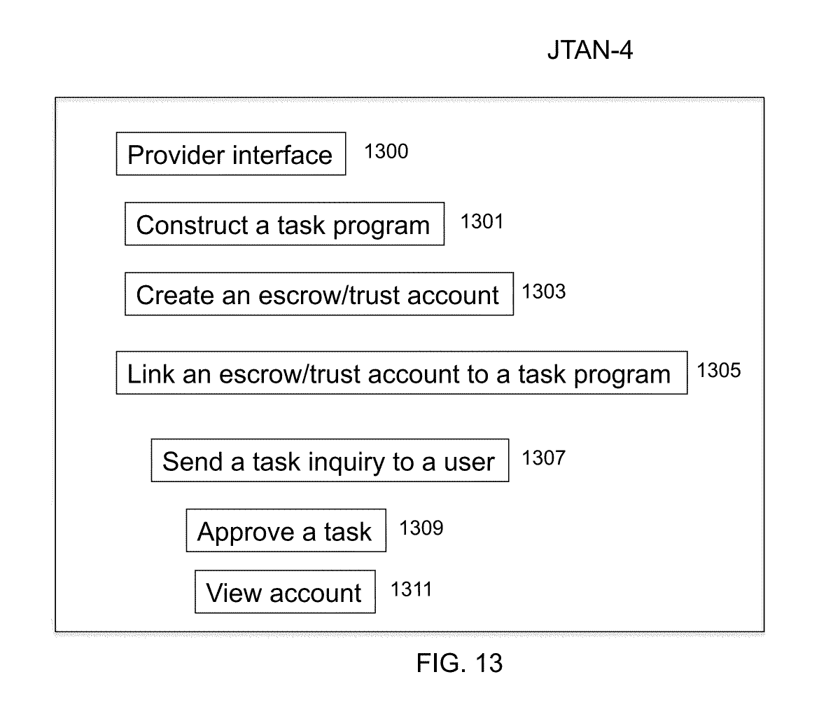

In reference to FIG. 13, an example provider interface 1300 is shown. The functional components associated with this interface may include construct a task program 1301, create an escrow or trust account 1303, link an escrow or trust account to a task program 1305, send a task inquiry to a user 1307, approve a performance of a task 1309 and view account summary 1311. Similar interface functions may be found in the U.S. Non-Provisional application Ser. No. 13/927,070, filed on Jun. 25, 2013, which is hereby incorporated by reference.

The above description is intended to provide one preferred embodiment example of the system. It is contemplated and intended that such systems and concepts may be altered and modified by an ordinary person in the art to customize and provide other known and obvious web associated functionalities.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. The claims as filed are intended to be as comprehensive as possible, and NO subject matter is intentionally relinquished, dedicated, or abandoned.

What is claimed is:

1. A task management system for providing incentives, comprising:
a plurality of computer processors configured with a plurality of modular computer functions, said plurality of modular computer functions comprising:
a provider-account database which stores a Provider with respective associated information and Provider ID;
a user-account database which stores a user with respective associated information and User ID;
a conditional-award-program database which stores a plurality of Conditional-Award programs configurable by a respective Provider, each Conditional-Award program having a Program ID and a Provider ID, wherein each of said Conditional-Award programs specifies a financial incentive in exchange for a user finishing a task;
a user-Trust-account database which stores a plurality of User-Trust-Accounts; and
a transaction engine component which provides a plurality of management functions for said conditional-award-program database, said provider-account database, said user-account database, said user-Trust-account database, wherein once a task is performed by a particular user and approved, an award calculated based on the particular Conditional-Award program is authorized and transferred to a Trust Account of said particular user.

2. The system of claim 1, further comprising a search engine for searching for conducting keyword searches.

3. The system of claim 1, wherein said system has a mobile system automatically installable and executable on a wireless cellular phone.

4. The system of claim 1, wherein a user is enabled to set up a User-Trust-account associated with a restrictive goal.

5. The system of claim 1, wherein the user is a child user and the provider is a parent, a charity sponsor or a teacher to the child user.

6. The system of claim 1, wherein the task is an educational activity or a parenting activity to a child.

7. The system of claim 1, wherein said escrow account is financed by a parent or a non-profit organization.

8. The system of claim 1, wherein said task is a contracted performance by a pair of contracting parties wherein the provider is one party and the user is the other party of the contracted performance.

9. The system of claim 1, further comprising a User Task Program database wherein a third Party Provider is enabled to store either a task program created on the system, or an interface to an outside task program or an uploaded task program.

10. The system of claim 1, further comprising a Content Creating Engine for creating a task Program.

11. A method for managing tasks having direct financial incentives, comprising the steps of:
providing a plurality of computer processors configured with a plurality of modular computer functions, wherein said a plurality of modular computer functions comprise:
a provider-account database which stores a Provider with respective associated information and Provider ID;
a user-account database which stores a user with respective associated information and User ID;
a conditional-award-program database which stores a plurality of Conditional-Award programs configurable by a respective Provider, each Conditional-Award program having a Program ID and a Provider ID, wherein each of said Conditional-Award programs specifies a financial incentive in exchange for a user finishing a task;
a user-Trust-account database which stores a plurality of User-Trust-Accounts; and
a transaction engine component which provides a plurality of management functions for said conditional-award-program database, said provider-account database, said user-account database, said user-Trust-account database, wherein once a task is performed by a particular user and approved, an award calculated based on the particular Conditional-Award program is authorized and transferred to a Trust Account of said particular user.

12. The method of claim 11, wherein said plurality of modular computer functions further comprise a search engine for searching for conducting keyword searches.

13. The method of claim 11, wherein said plurality of modular computer functions comprises a mobile application that is automatically installable and executable on a wireless cellular phone.

14. The method of claim 11, wherein the user is enabled to set up a User-Trust-account associated with a restrictive goal.

15. The method of claim 11, wherein the user is a child user and the provider is a parent, a charity sponsor or a teacher to the child user.

16. The method of claim 11, wherein the task is an educational activity or a parenting activity to a child.

17. The method of claim 11, wherein said escrow account is financed by a parent or a non-profit organization.

18. The method of claim 11, wherein said task is a contracted performance by a pair of contracting parties wherein the provider is one party and the user is the other party of the contracted performance.

19. The method of claim 11, wherein said plurality of modular computer functions further comprise a User Task Program database wherein a third Party Provider is enabled to store either a task program created on the system, or an interface to an outside task program or an uploaded task program.

20. The method of claim 11, f wherein said plurality of modular computer functions further comprise a Content Creating Engine for creating a task Program.
